(19) United States
(12) Patent Application Publication
(10) Pub. No.: US 2007/0231744 A1
(43) Pub. Date: Oct. 4, 2007

(54) Holographic recording medium

(75) Inventors: Norikatsu Sasao, Tokyo (JP); Akiko Hirao, Chiba-shi (JP); Rumiko Hayase, Yokohama-shi (JP); Kazuki Matsumoto, Kawasaki-shi (JP); Takahiro Kamikawa, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/723,759

(22) Filed: Mar. 21, 2007

(30) Foreign Application Priority Data
Mar. 29, 2006 (JP) 2006-090597

(51) Int. Cl. G03H 1/04; G03C 1/00

(52) U.S. Cl. 430/281.1; 430/1; 430/2; 430/280.1; 359/3

(57) ABSTRACT

A holographic recording medium includes a recording layer containing a matrix material, a photoactive monomer having an ethylenic unsaturated bond dispersed in the matrix material and a photoinitiator, and a polymerization-terminating layer formed on at least one surface of the recording layer.

### CROSS-REFERENCE TO RELATED APPLICATIONS

This application is based upon and claims the benefit of priority from prior Japanese Patent Application No. 2006-090597, filed Mar. 29, 2006, the entire contents of which are incorporated herein by reference.

### BACKGROUND OF THE INVENTION

1. Field of the Invention

The invention relates to a holographic recording medium.

2. Description of the Related Art

Holographic memory that holds data in a form of holography is capable to record data in high capacity. Much attention has been paid on the development of such material that enables to record data holographically. Such materials include Omnidex [registered trademark, DuPont Company] which is one type of photosensitive polymer film (photopolymer). In this case, a photoactive monomer, a photoinitiator and a sensitizing dye are well dispersed throughout a thermoplastic binder to form a photopolymer. When interference pattern is exposed on to the photopolymer, the photoinitiator at a high optical field, i.e., at a bright region, decomposes to give initiating radicals, which initiate radical polymerization. Because the photoactive monomers diffuse from the dark regions to the bright regions, further polymerization in the bright regions is promoted to give polymers with high molecular weight. This leads to disparity in density and in refractive index between the bright regions and the dark regions in the photopolymer. The disparity follows the profile of the interference pattern that has been exposed, and this is how hologram is recorded.

A holographic recording medium in which a photoactive monomer is dispersed in a cross-linked polymeric matrix is disclosed in JP-A 11-252303 (KOKAI). Furthermore, a holographic recording medium in which a photoactive monomer is dispersed in an epoxy resin matrix is also proposed (see T. J. Trentler, J. E. Boid and V. L. Colvin, “Epoxy-Photopolymer Composites: Thick Recording Media for Holographic Data Storage”; Proceedings of SPIE, 2001, Vol. 4296, pp. 259-266).

Many studies to improve the performance of the photopolymer that is suitable for holographic recording is currently under progress. One of the tasks that is strongly investigated is to achieve higher refractive index modulation under lower amount of irradiation; in other words, the improvement of the sensitivity. However, increase in sensitivity also leads to a facile sensitization under weak light. Undesirable reactions may occur in the medium by irradiation of, for example, natural light. In order to overcome such a problem, a trace amount of inhibitor may be dispersed in the recording layer to prevent such polymerization (dark reaction) to increase the storage stability (see JP-A 7-5796 [KOKAI]).

As described above, a polymerization inhibitor is dispersed in the recording layer, to prevent dark reaction in the holographic recording medium. In such holographic recording medium, it is necessary to pre-expose the medium before the recording process to inactivate the inhibitor. The pre-exposure must be sufficient enough so that the inhibitor is fully quenched. However, excessive pre-exposure would result in undesired consumption of the monomer and the initiator that should be taking part in the recording process. This undesired consumption deteriorates the recording sensitivity. In addition, this pre-exposure process complicates the system in the recording drive.

### BRIEF SUMMARY OF THE INVENTION

The invention relates to a holographic recording medium, comprising: a recording layer that consists of a matrix material, a photoactive monomer and a photoinitiator both dispersed in the matrix material; and a polymerization-terminating layer formed on at least one surface of the recording layer. The photosensitive monomer has an ethylenic unsaturated bond.

### BRIEF DESCRIPTION OF THE SEVERAL VIEWS OF THE DRAWING

FIG. 1 is a cross-sectional view of a holographic recording medium according to an embodiment;

FIG. 2 is a cross-sectional view of a holographic recording medium according to an embodiment;

FIG. 3 is a schematic diagram of a holographic recording/reconstructing apparatus according to an embodiment;

FIG. 4 is a schematic diagram of a holographic recording/reconstructing apparatus according to an embodiment; and

FIG. 5 is a schematic diagram of a holographic recording/reconstructing apparatus according to an embodiment.

### DETAILED DESCRIPTION OF THE INVENTION

Hereinafter, embodiments of the present invention will be described in detail.

Components for the recording layer of the holographic recording media in embodiments will be described first.

[Matrix Material]

In the embodiments, the matrix material for the recording layer includes a cross-linked polymer. Examples of the polymerization reaction to form the matrix material of cross-linked polymer include cationic polymerization of an epoxy compound, cationic polymerization of vinyl ether, epoxy-amine polymerization, epoxy-anhydride polymerization and epoxy-mercaptan polymerization. A suitable matrix material is a cured resin obtained by the reaction between an epoxy compound and a curing agent.

Examples of the epoxy compounds include 1,4-butanediol diglycidyl ether, 1,6-hexanediol diglycidyl ether, 1,8-octanediol diglycidyl ether, diethylene glycol diglycidyl ether, polyethylene glycol diglycidyl ether, polypropylene glycol diglycidyl ether, neopentylglycol diglycidyl ether, diepoxyoctane, resorcinol diglycidyl ether, diglycidyl ether of bisphenol A, diglycidyl ether of bisphenol F, 3,4-epoxycyclohexenylmethyl-3′,4′-epoxycyclohexenecarboxylate, and epoxypropoxypropyl-terminated polydimethylsiloxane. These compounds may be used alone or in a combination of two or more.

Curing agents for the epoxy compound include amines, phenols, organic acid anhydrides and amides. More specifically, examples of the curing agents include ethylenediamine, diethylenetriamine, triethylenetetramine, tetraethylenepentamine, pentaethylenehexamine, hexamethylenediamine, menthenediamine, isophoronediamine, bis(4-amino-3-methyldicyclohexyl)methane, bis(aminomethyl)cyclohexane, N-aminoethylpiperazine, m-xylylenediamine, 1,3-diaminopropane, 1,4-diaminobutane, trimethylhexamethylenediamine, iminobispropylamine, bis(hexamethylene)triamine, 1,3,6-trisaminomethylhexane, dimethylaminopropylamine, aminoethylethanolamine, tri(methylamino)hexane, m-phenylenediamine, p-phenylenediamine, diaminodiphenylmethane, diaminodiphenylsulfone, 3,3′-diethyl-4,4′-diaminodiphenylmethane, maleic anhydride, succinic anhydride, tetrahydrophthalic anhydride, methyltetrahydrophthalic anhydride, methylnadic anhydride, hexahydrophthalic anhydride, methylhexahydrophthalic acid, methylcyclohexenetetracarboxylic anhydride, phthalic anhydride, trimellitic anhydride, benzophenonetetracarboxylic anhydride, dodecenylsuccinic anhydride, ethylene glycol bis(anhydrotrimellitate), phenol novolak resin, cresol novolak resin, polyvinylphenol, terpene phenolic resin and polyamide resin.

A curing catalyst may also be added to the epoxy compound and the curing agent, if necessary. Curing catalysts include basic catalysts such as tertiary amines, organic phosphine compounds, imidazole compounds, and derivatives thereof. More specifically, examples of the curing catalysts include triethanolamine, piperidine, N,N′-dimethylpiperazine, 1,4-diazadicyclo(2,2,2)octane(triethylenediamine), pyridine, picoline, dimethylcyclohexylamine, dimethylhexylamine, benzyldimethylamine, 2-(dimethylaminomethyl)phenol, 2,4,6-tris(dimethylaminomethyl)phenol, 1,8-diazabicyclo[5,4,0]undec-7-ene (DBU) or a phenol salt thereof, trimethylphosphine, triethylphosphine, tributylphosphine, triphenylphosphine, tri(p-methylphenyl)phosphine, 2-methylimidazole, 2,4-dimethylimidazole, 2-ethyl-4-methylimidazole, 2-phenylimidazole, 2-phenyl-4-methylimidazole, and 2-heptaimidazole. Latent catalysts such as boron trifluoride-amine complex, dicyandiamide, organic acid hydrazide, diaminomaleonitrile and derivatives thereof, melamine and derivatives thereof and amine imide may also be used. Adding a compound having active hydrogen such as phenols or salicylic acid could help to promote the cure.

[Monomer]

Photoactive monomers having at least one ethylenic unsaturated bond include, for example, an unsaturated carboxylic acid, an unsaturated carboxylic acid ester, an unsaturated carboxylic acid amide, and a vinyl compound. More specifically, examples of the photoactive monomers include acrylic acid, methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, 2,4,6-tribromophenyl acrylate, isobornyl acrylate, adamantyl acrylate, methacrylic acid, methyl methacrylate, propyl methacrylate, butyl methacrylate, phenyl methacrylate, phenoxyethyl acrylate, chlorophenyl acrylate, adamantyl methacrylate, isobornyl methacrylate, N-methylacrylamide, N,N-dimethylacrylamide, N,N-methylene bisacrylamide, acryloylmorpholine, vinylpyridine, styrene, bromostyrene, chlorostyrene, tribromophenyl acrylate, trichlorophenyl acrylate, tribromophenyl methacrylate, trichlorophenyl methacrylate, vinylbenzoate, 3,5-dichlorovinylbenzoate, vinylnaphthalene, vinyl naphthoate, naphthyl methacrylate, naphthyl acrylate, N-phenyl methacrylamide, N-phenylacrylamide, N-vinylpyrrolidinone, N-vinylcarbazole, 1-vinylimidazole, bicyclopentenyl acrylate, 1,6-hexanediol diacrylate, pentaerythritol triacrylate, pentaerythritol tetraacrylate, dipentaerythritol hexaacrylate, diethylene glycol diacrylate, polyethylene glycol diacrylate, polyethylene glycol dimethacrylate, tripropylene glycol diacrylate, propylene glycol trimethacrylate, diallyl phthalate, and triallyl trimellitate.

The amount of the photoactive monomer added is preferably 1 to 50 wt %, more preferably 3 to 30 wt %, of the recording layer. Sufficient disparity in the refractive index can be achieved if the amount of the monomer is over 1 wt %. Volume shrinkage can be made little having the amount of monomer less than 50 wt %. Small volume shrinkage leads to a high resolution of the reconstructed image.

[Photoinitiator]

The photoinitiator is selected in accordance with the wavelength of a recording beam. Examples of the photoinitiators include benzoin ether, benzyl ketal, benzyl, acetophenone derivatives, aminoacetophenones, benzophenone derivatives, acyl phosphine oxides, triazines, imidazole derivatives, organic azide compounds, titanocenes, organic peroxides, and thioxanthone derivatives. More specifically, examples of the photoinitiator include benzyl, benzoin, benzoin ethyl ether, benzoin isopropyl ether, benzoin butyl ether, benzoin isobutyl ether, 1-hydroxycyclohexyl phenyl ketone, benzyl methyl ketal, benzyl ethyl ketal, benzyl methoxyethyl ether, 2,2′-diethylacetophenone, 2,2′-dipropylacetophenone, 2-hydroxy-2-methylpropiophenone, p-tert-butyltrichloroacetophenone, thioxanthone, 1-chlorothioxanthone, 2-chlorothioxanthone, 2-methylthioxanthone, 2-isopropylthioxanthone, 3,3′,4,4′-tetra(t-butylperoxycarbonyl)benzophenone, 2,4,6-tris(trichloromethyl)-1,3,5-triazine, 2-(p-methoxyphenyl)-4,6-bis(trichloromethyl)-1,3,5-triazine, 2-[(p-methoxyphenyl)ethylene]-4,6-bis(trichloromethyl)-1,3,5-triazine, diphenyl-(2,4,6-trimethylbenzoyl)phosphine oxide, Irgacure® 149, 184, 369, 651, 784, 819, 907, 1700, 1800, 1850, and so forth, available from Ciba Specialty Chemicals, di-t-butyl peroxide, dicumyl peroxide, t-butyl cumyl peroxide, t-butyl peroxyacetate, t-butyl peroxyphthalate, t-butyl peroxybenzoate, acetyl peroxide, isobutyryl peroxide, decanoyl peroxide, lauroyl peroxide, benzoyl peroxide, t-butyl hydroperoxide, cumene hydroperoxide, methyl ethyl ketone peroxide, and cyclohexanone peroxide. A titanocene compound such as Irgacure® 784 (Ciba Specialty Chemicals) is preferable for the photoinitiator when a blue laser beam is used for recording.

The amount of the photoinitiator is preferably 0.1 to 20 wt %, more preferably 0.2 to 10 wt %, of the recording layer. Having the amount of the photoinitiator 0.1 wt % or more, sufficient disparity in the refractive index can be achieved. When the amount of the photoinitiator is 20 wt % or less, light absorption would be small enough to achieve high sensitivity and high diffraction efficiency.

[Other Components for Recording Layer]

It is also favorable to add, if necessary, sensitizing dyes, such as cyanine, merocyanine, xanthene, cumarin and eosine. Silane coupling agents and plasticizers can also be added.

The optical transparency of the recording layer containing the aforementioned components for the recording beam is preferably 10% to 95%, more preferably 20% to 90%. If the optical transparency is 10% or more, desirable sensitivity and diffraction efficiency can be achieved. Having the optical transparency of 95% or less makes it possible to prevent the disadvantage that information is inaccurately recorded due to the scattering of the recording beam.

[Polymerization-Terminating Layer]

The polymerization-terminating layer consists of a polymerization inhibitor (hereinafter, referred to as an inhibitor). The inhibitor is not particularly limited, as long as it terminates or inhibits polymerization reaction. A chain-transfer agent that inactivates radicals generated in chain-transfer reaction is also included in the inhibitor hereinafter.

Examples of the inhibitors include compounds having at least; one phenolic hydroxyl group, a hindered amine structure, a quinoid moiety, a radical moiety, a hydroxylamine-group, a nitro-group, a nitroso-group, a nitrone-group, metal salts, metal complexes, iodine, sulfur-based polymerization inhibitors, iniferters, reversible addition-fragmentation chain-transfer agents (hereinafter, RAFT reagents), and phosphorus-based polymerization inhibitors, and an aromatic ring or a heterocyclic ring substituted with an imino group. The inhibitor may be used alone or in a combination of two or more.

In particular, compounds having a radical moiety or a nitrone moiety is preferable as for the reasons described later.

Hereinafter, the aforementioned inhibitors will be described in detail.

The compound having at least one phenolic hydroxyl group is represented by the following Formula (I). In Formula (I), R1 to R5 represent a substituent group, such as a hydroxyl group, a hydrogen atom, an aliphatic group that may be partially substituted, an aromatic group that may be partially substituted, or a heterocyclic group that may be partially substituted. The represented substituted group is not particularly limited thereto. One or more of the substituent groups R1 to R5 may be a polymer main chain.

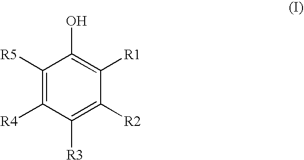

Examples of the compounds represented by Formula (I) include catechol, alkylcatechols such as 2-methylcatechol, 3-methylcatechol, 4-methylcatechol, 2-ethylcatechol, 3-ethylcatechol, 4-ethylcatechol, 2-propylcatechol, 3-propylcatechol, 4-propylcatechol, 2-n-butylcatechol, 3-n-butylcatechol, 4-n-butylcatechol, 2-tert-butylcatechol, 3-tert-butylcatechol, 4-tert-butylcatechol, and 3,5-di-tert-butylcatechol; resorcinol, alkylresorcinols such as 2-methylresorcinol, 4-methylresorcinol, 2-ethylresorcinol, 4-ethylresorcinol, 2-propylresorcinol, 4-propylresorcinol, 2-n-butylresorcinol, 4-n-butylresorcinol, 2-tert-butylresorcinol, and 4-tert-butylresorcinol; 1,4-hydroquinone, alkylhydroquinones such as methylhydroquinone, ethylhydroquinone, propylhydroquinone, tert-butylhydroquinone, and 2,5-di-tert-butylhydroquinone; 1-naphthol, 2-naphthol, pyrogallol, fluoroglycine, phenol resins, and cresol resins.

Examples of the compounds having a hindered amine structure include diphenylamine, and diphenylpicrylhydrazine.

Examples of the compound having a quinoid moiety include benzoquinone and the like.

Examples of compounds having a radical moiety is a compound containing a radical that is sufficiently stable at room temperature in open air. Sufficiently stable radicals have a half-life of one hour or more at room temperature in open air. A half-life less than one hour inevitably results in decrease in the density of the radicals in the polymerization-terminating layer during the preparation of the medium. The decrease in the density of radicals would diminish the effect of this invention. Examples of the compounds having a half-life of one hour or more include nitroxide derivatives, compounds having a phenoxyl radical, and compounds having a triarylaminium radical.

The nitroxide derivative is represented by Formula (II). In the Formula, each of R6 and R7 is a substituent group and selected from a hydrogen atom, an amino group, a trialkylammonio group, an ammonio group, a hydroxyl group, an aliphatic group, an aromatic group, an alkoxy group, a cyano group, a nitro group, a nitroso group, a halogen atom, an aldehyde group, a carboxyl group, and a carbonyl group. When R6 or R7 contains an aliphatic group, the aliphatic group may be saturated or unsaturated; substituted or unsubstituted; or linear, branched or cyclic group. When R6 or R7 contains a hydroxyl or carboxyl group, the hydroxyl or carboxyl group may form a salt with a metal. More specifically, R6 and R7 are represented by Formulae (III), (IV), or (V). R8 to R16 represent a substituent group and are selected from a hydrogen atom, an amino group, a trialkylammonio group, an ammonio group, a hydroxyl group, an aliphatic group, an aromatic group, an alkoxy group, a cyano group, a nitro group, a nitroso group, a halogen atom, an aldehyde group, a carboxyl group, and a carbonyl group. When any one of R8 to R16 contains an aliphatic group, the aliphatic group may be saturated or unsaturated; substituted or unsubstituted; or linear, branched or cyclic. When any one of R8 to R16 contains a hydroxyl or carboxyl group, the hydroxyl or carboxyl group may form a salt with a metal. R17 represents an oxygen or sulfur atom. Typical examples thereof include the compounds (A1) to (A15), or the like. When one or both of R6 and R7 contain a phenyl group, the phenyl group is preferably substituted at the p-position with a bulky substituent group such as t-butyl, and more preferably, additionally with another bulky substituent group at the o-position, from the point of stability of the radical.

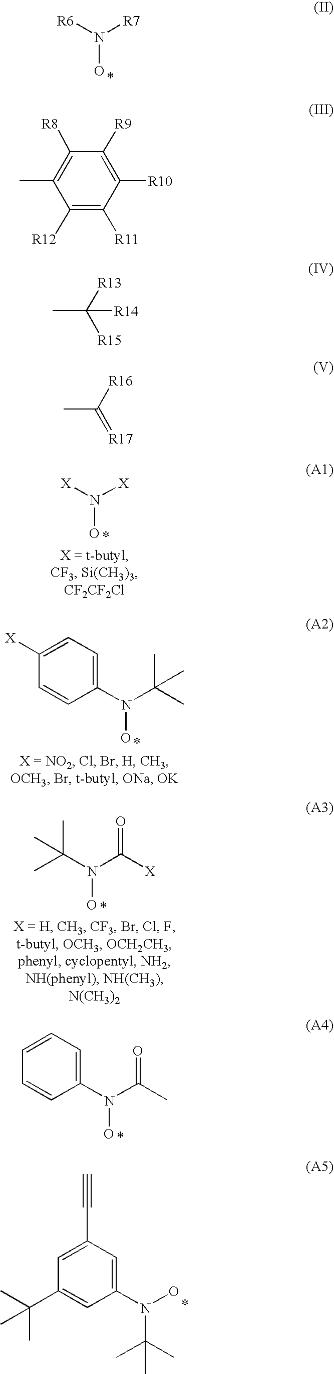

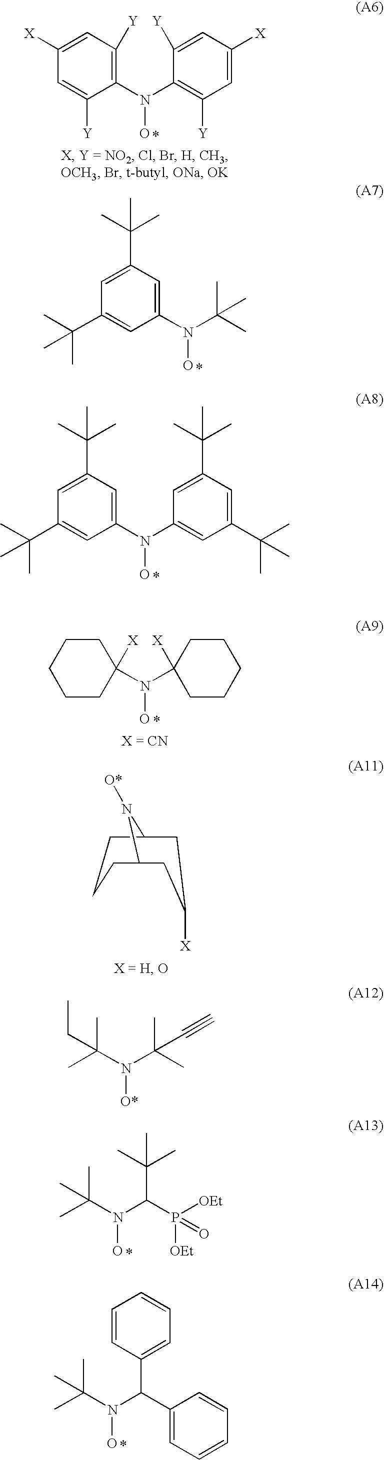

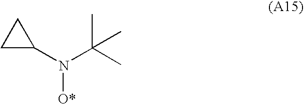

In Formula (II), the nitroxide derivative may have a nitronylnitroxide structure shown in Formula (VII). In this case, it is expected that the radical may become more stable because of delocalization of the electron. In Formula (VII), R18 to R20 each represent a substituent group and are selected from a hydrogen atom, an amino group, a trialkylammonio group, an ammonio group, a hydroxyl group, an aliphatic group, an aromatic groups, an alkoxy groups, a cyano group, a nitro group, a nitroso group, a halogen atom, an aldehyde group, a carboxyl group, and a carbonyl group. When any one of R18 to R20 contains an aliphatic group, the aliphatic group may be saturated or unsaturated; substituted or unsubstituted; or linear, branched or cyclic. When any one of R18 to R20 contains a hydroxyl or carboxyl group, the hydroxyl or carboxyl group may form a salt with a metal. Typical examples of nitronylnitroxide derivatives include the compounds represented by (B1) to (B3), and the like.

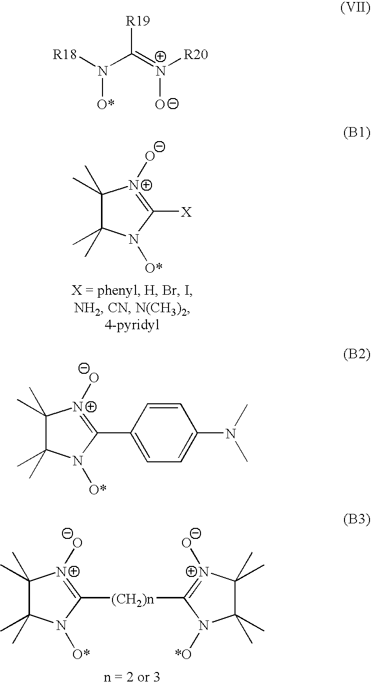

In Formula (II), R6 and R7 may form a ring, and typical examples of such compounds include those represented by Formulae (IX), (X), (XI) and (XII). R21 to R24 each represent a linear, branched or cyclic alkyl group, and R21 and R22, or R23 and R24, may form a part of a cyclic hydrocarbon, bridged hydrocarbon or a heterocyclic compound. The cyclic hydrocarbon, bridged hydrocarbon, or heterocyclic compound may be substituted or unsubstituted. R25 to R27 each represent a substituent group, and are a group having at least one selected from a hydrogen atom, an amino group, a trialkylammonio group, an ammonio group, a hydroxyl group, an aliphatic group, an aromatic group, an alkoxy group, a cyano group, a nitro group, a nitroso group, a halogen atom, an aldehyde group, a carboxyl group, and a carbonyl group. When any one of R25 to R27 contains a hydroxyl or carboxyl group, the hydroxyl or carboxyl group may form a salt with a metal. R25 and R26, R26 and R27, or R25 and R27, may form a part of a cyclic hydrocarbon, a bridged hydrocarbon or a heterocyclic compound. The cyclic hydrocarbon, bridged hydrocarbon, or heterocyclic compound may be substituted or unsubstituted. Typical examples of the compounds represented by Formulae (IX), (X), (XI), and (XII) are shown below as C1 to C34, D1 to D6, E1 to E4, and F1 to F2, respectively.

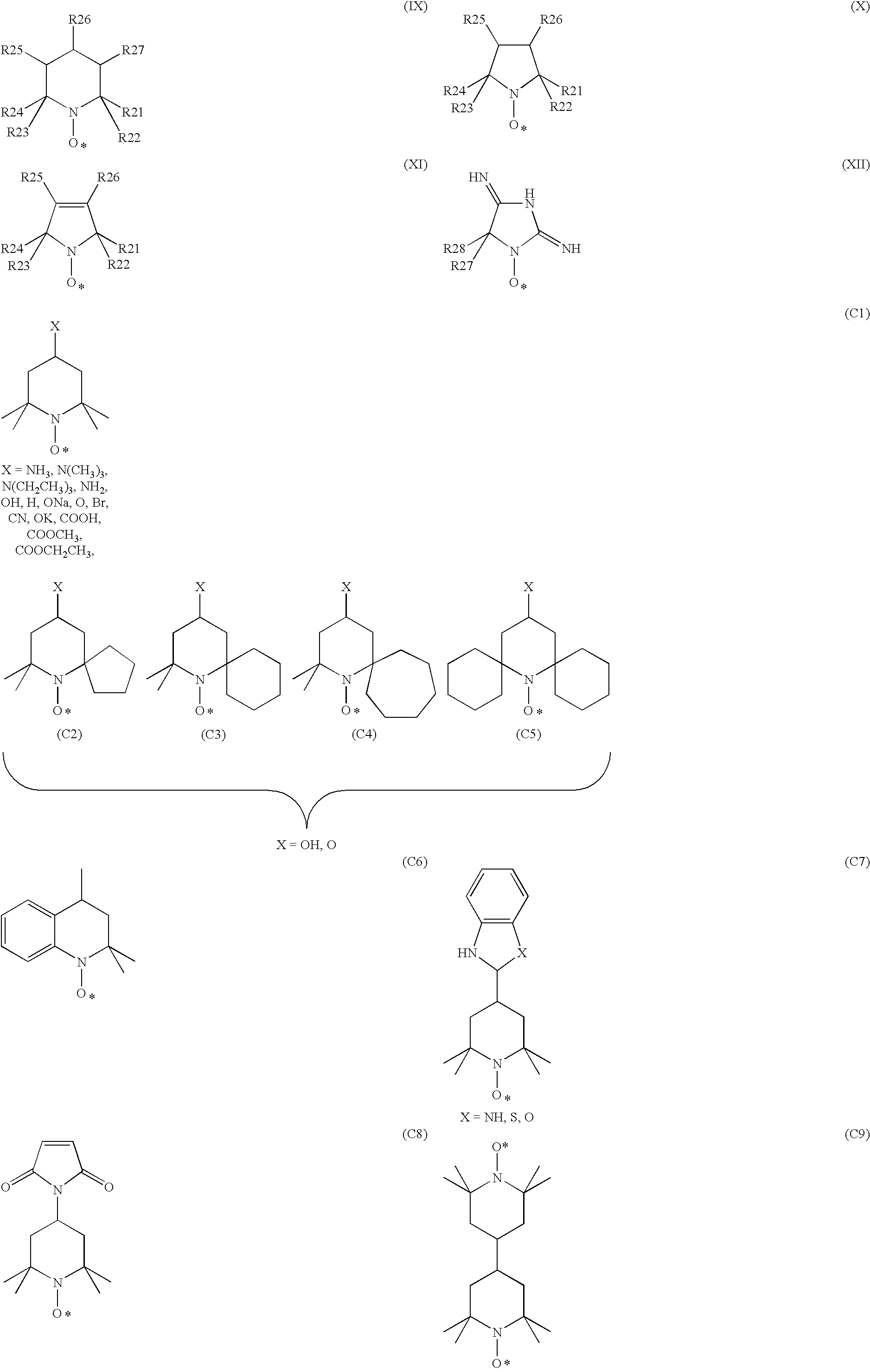

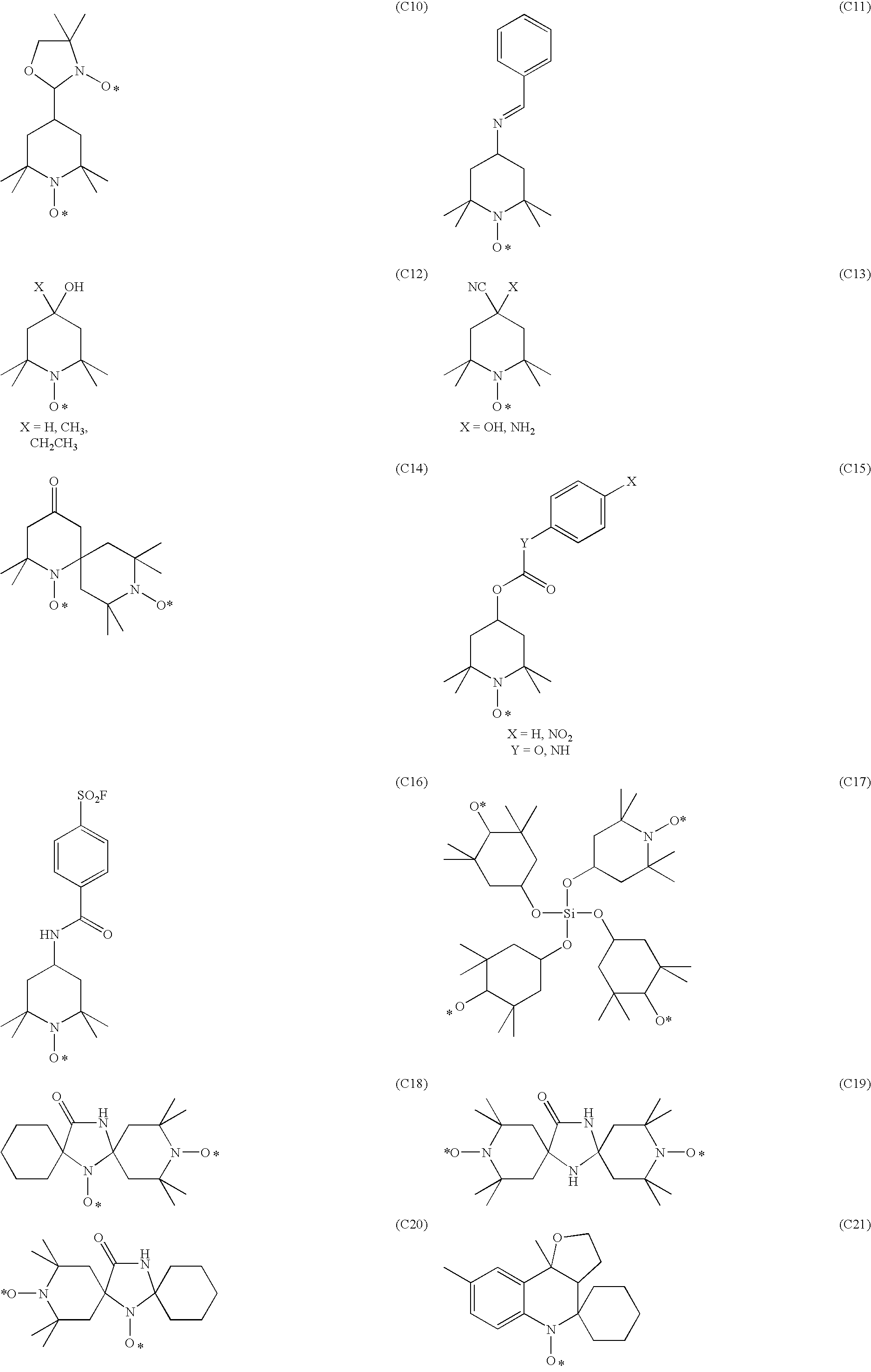

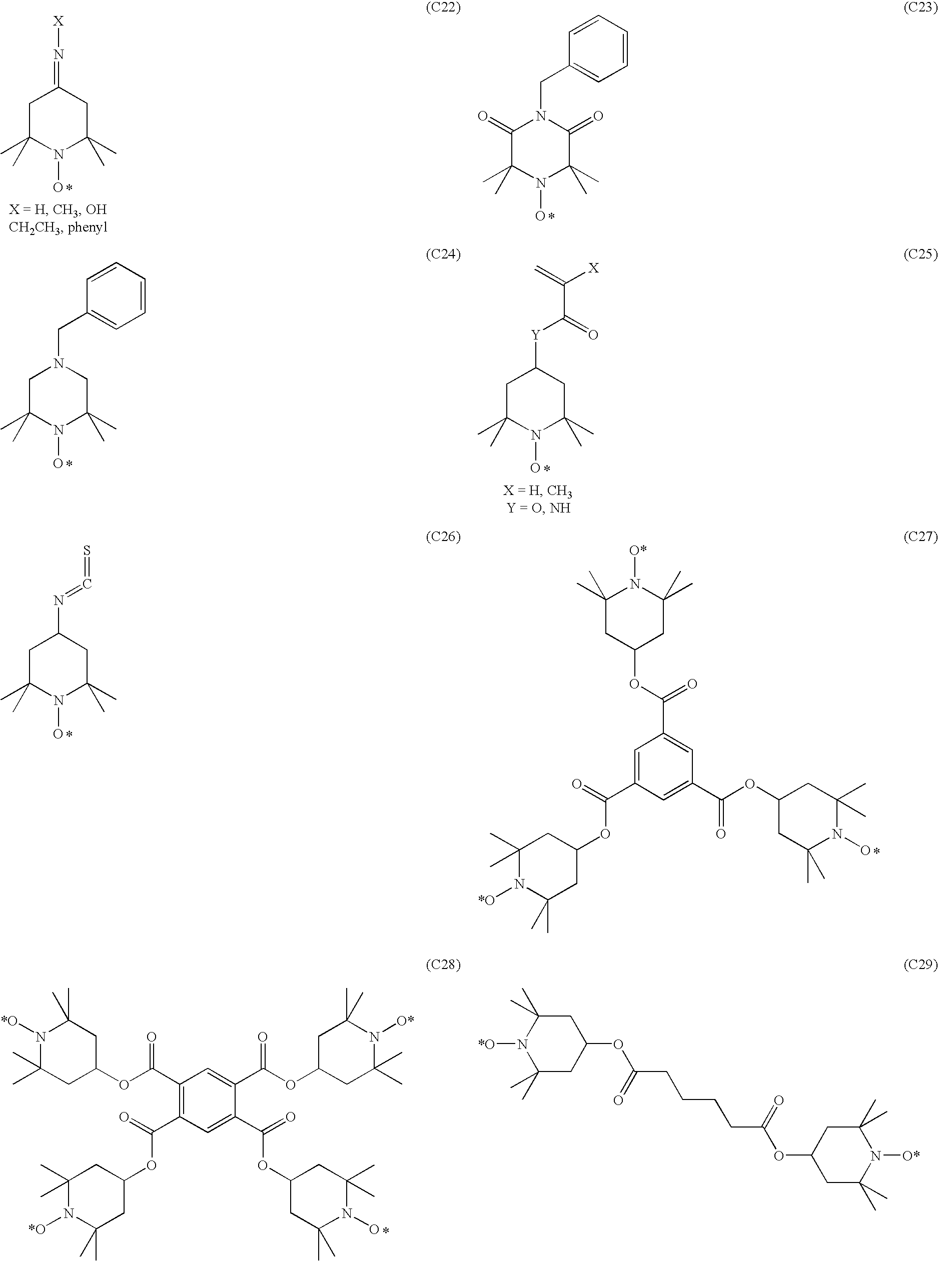

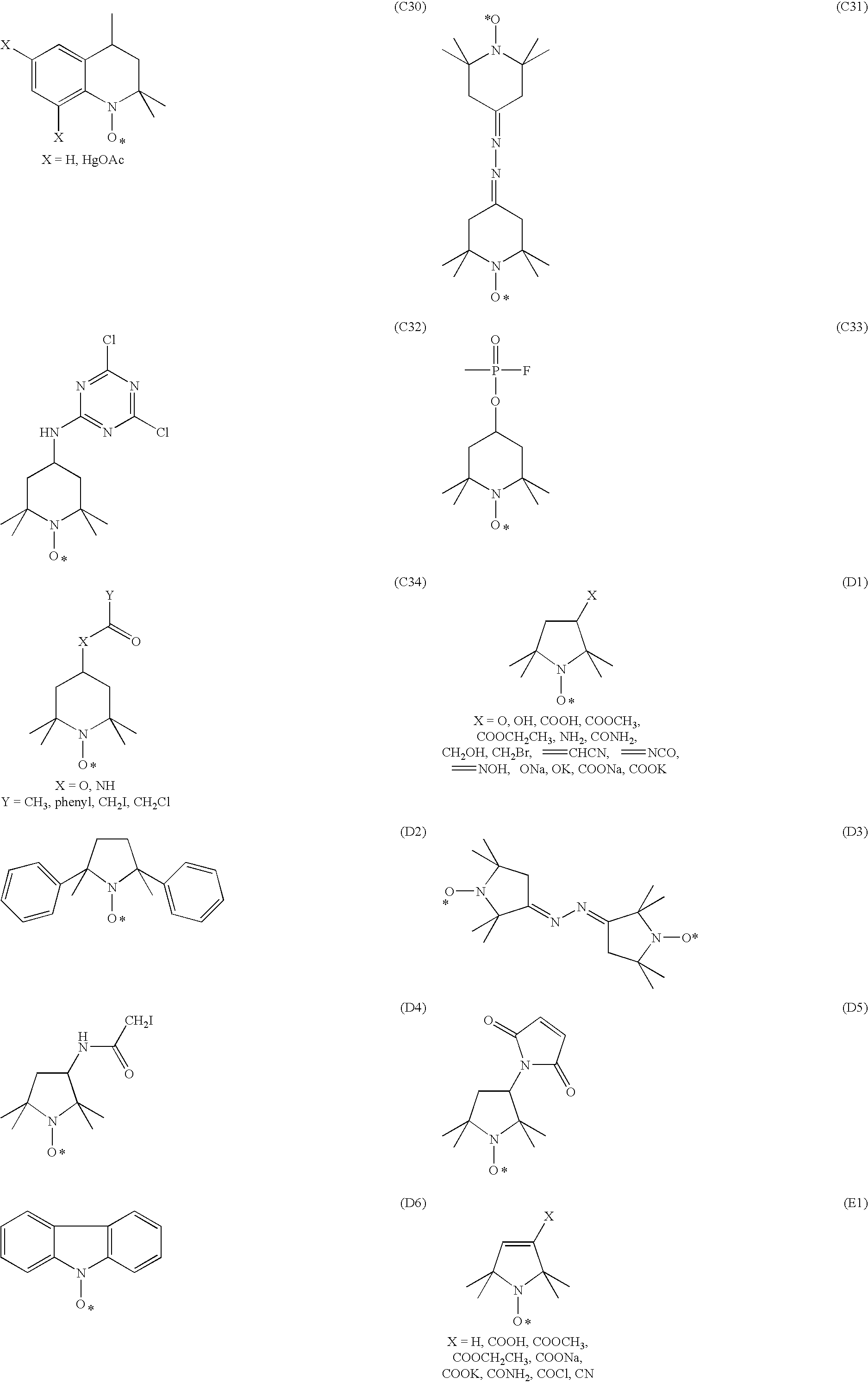

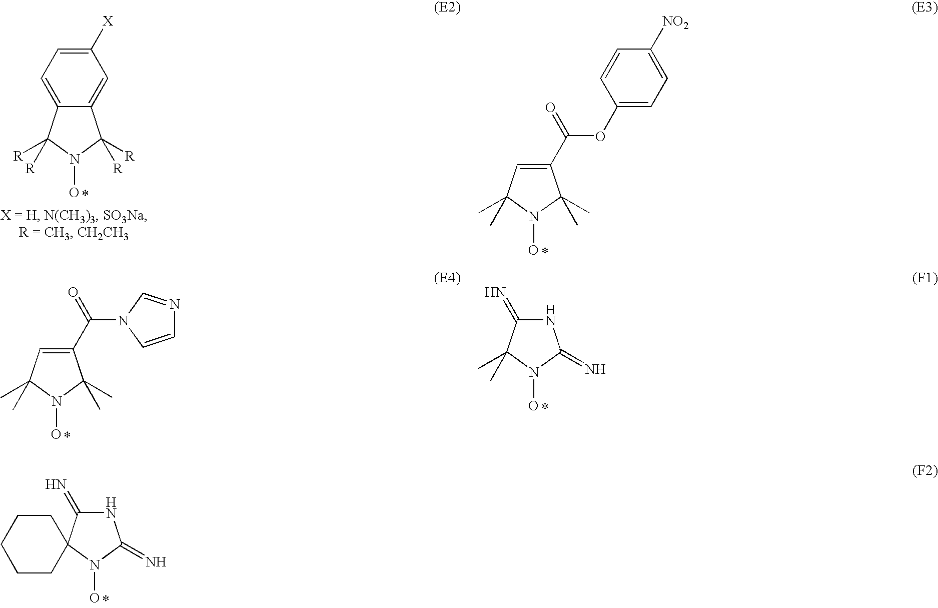

Other nitroxides represented by Formula (II), but do not belong to the compounds represented by general Formulae (VI) to (XII), include compounds represented by G1 to G5.

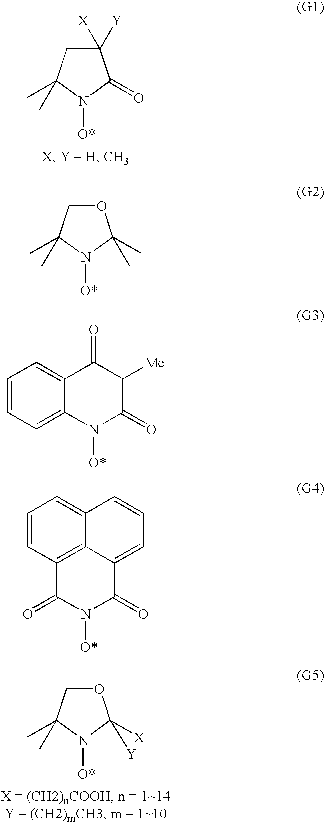

The nitroxide derivative represented by Formula (II) may form a part of a side chain of polymer, and examples thereof include the compounds represented by H1 to H14.

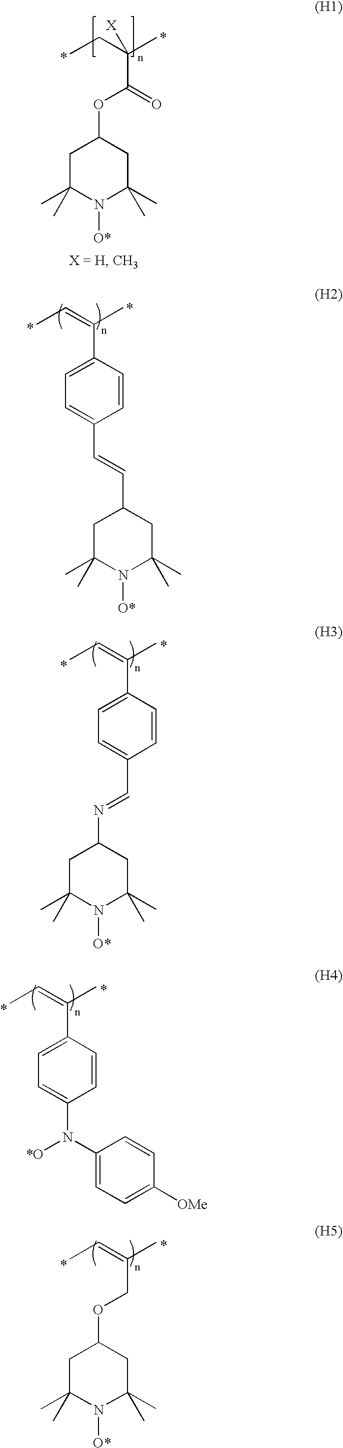

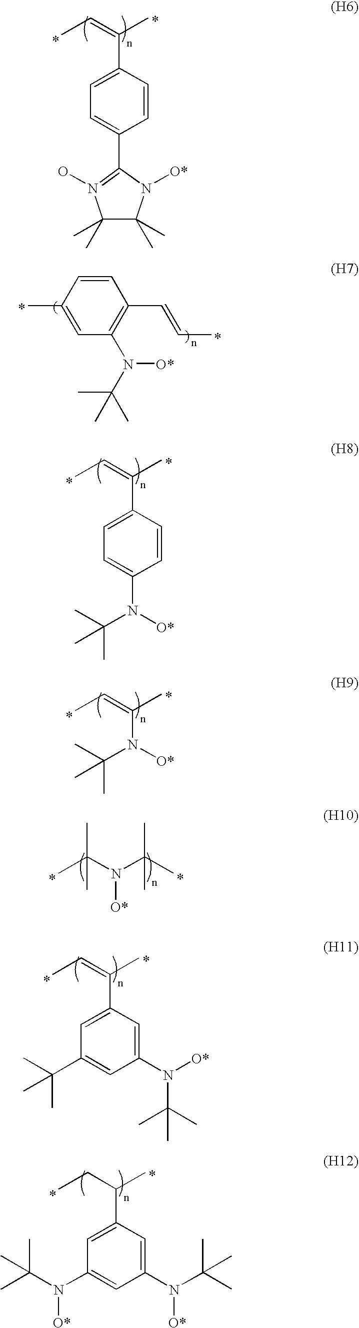

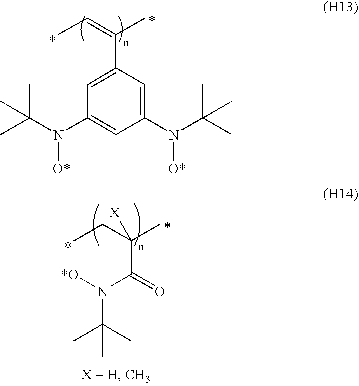

In addition, Fremy salts represented by *O—N(SO₃K)₂ are also included in the nitroxide derivatives.

Examples of the compound having a phenoxy radical include 2,4,6-tri-tert-butylphenoxy radical and galvinoxyl.

The compound having a triarylaminium radical includes, for example, *N⁺(C₆H₆)₃.

Among the compounds that have a sufficiently stable radical in their structure, nitroxide derivatives are particularly preferable, for they tend to have a longer half-life and they tend to be superior in stability compared to other radical species.

Examples of the hydroxylamine-containing compounds include precursors for the nitroxide derivatives (such as 2,2,6,6-tetramethylpiperidine-1-hydroxyl, di-tert-butylhydroxylamine, and N-tert-butyl-N-hydroxylamine), hydroxylamine, N-benzoyl-N-phenylhydroxylamine, N-(tert-butyl benzyloxycarbamate, N,O-bis(trifluoroacetyl)hydroxylamine, N,O-bis(trimethylsilyl)hydroxylamine, N-(tert-butyl)hydroxylamine, N-carbobenzoxylhydroxylamine, N-cinnamoyl-N-(2,3-xylyl)hydroxylamine, N,N-dibenzylhydroxylamine, N,N-diethylhydroxylamine, N,O-dimethylhydroxylamine, 4-hydroxyamine quinoline-N-oxide, tert-butyl N-hydroxycarbamate, N-methoxy-N-methylacetamide, N-methyl-N,O-bistrimethylsilyl, N-methylfluorohydroxamic acid, N-methylhydroxylamine, N, N,O-triacetylhydroxylamine, N,N,O-tris(trimethylsilyl)hydroxylamine, O-allylhydroxylamine, O-benzylhydroxylamine, tert-butyl N-(benzyloxy)carbamate, N,O-bis(trifluoroacetyl)hydroxylamine, N,O-bis(trimethylsilyl)hydroxylamine, carboxymethoxylamine, N,O-dimethylhydroxylamine, hydroxylamine-O-sulfonic acid, O-isobutylhydroxylamine, O-4-nitrobenzylhydroxylamine, O-(2,3,4,5,6-pentafluorobenzyl)hydroxylamine, N,N,O-triacetylhydroxylamine, O-(2-trimethylsilylethyl)hydroxylamine, O-(trimethylsilyl)hydroxylamine, and N,N,O-tris(trimethylsilyl)hydroxylamine. The above hydroxylamines may be in a form of a hydrochloride or sulfate salt.

Examples of the nitro-containing compounds include nitrobenzene and trinitrobenzene.

Examples of the nitroso-containing compounds include 2-methyl-2-nitrosopropane, nitrosobenzene, and 2,4,6-tri-tert-butylnitrosobenzene.

Examples of the nitrone-containing compounds include α-phenyl(tert-butyl)nitrone, N-tert-butyl-α-phenylnitrone, and N-tert-butyl-α-(4-pyridyl-1-oxide)nitrone. The nitrone-containing compounds are favorable, because each of them is converted to nitroxide by trapping a radical. The nitroxide is capable to capture another radical, and thus superior in radical trapping efficiency with one functional group.

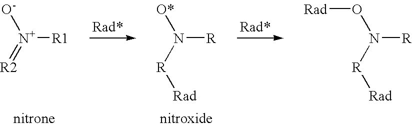

Examples of the metal salts include FeX₃ and CuX₂ (wherein, X represents a halogen atom).

Examples of the metal complexes include tetraphenylporphyrin cobalt (II) complex.

Examples of the sulfur-based polymerization inhibitors include dilauryl thiodipropionate, distearyl dipropionate, dithiobenzoyl sulfide, dibenzyl tetrasulfide, 2,2,6,6-tetramethylpiperidine-N-ylthiyl, and diphenyl sulfide.

Examples of the iniferters include tetraethylthiuram disulfide, benzyl-N,N-diethyl dithiocarbamate, xylylene bis(N,N-diethyldithiocarbamate), (Ph)₂-CR—CR-(Ph)₂ (where Ph represents a benzene ring; and R represents an ethyl, cyano, or phenoxy group).

The most favorable examples of the RAFT reagents include thiocarbonylthio compounds such as benzyl dithiobenzoate.

Examples of the phosphorus-based polymerization inhibitors include triphenyl phosphite and the like.

Examples of the compounds having an aromatic ring substituted with an imino group include phenothiazine derivatives, phenoxazine derivatives, dihydrophenazine derivatives, and hydroquinoline derivatives.

Use of a polymer having one of the inhibitors stated above on its side chain is favorable as the material for the polymerization-terminating layer. This would avoid the inhibitors to dissolve into the recording layer. From this point of view, it is more favorable to add cross-linkers partly into the polymer chain that has the inhibitor on its side chain. When it is applied on a substrate the cross-linkers cross-link to give insoluble polymer. The cross-linked polymer effectively prevents the inhibitor to dissolve into the recording layer. One can also adhere the inhibitor directly to the substrate or the gap layer. One can also apply the inhibitor directly to the substrate of the gap layer without having it as the side chain of a polymer, if its solubility into the recording layer is limited.

Examples of the polymers having an inhibitor on its side chain include compounds represented by Formulae H1 to H14.

It is possible to form a polymerization-terminating layer by dissolving the polymer having an inhibitor on its side chain in a solvent and applying the solution on a substrate by spin coating, dip coating or casting. In order to control the solubility, the transparency and the concentration of the inhibitor, the polymer having an inhibitor on its side chain may form a copolymer with another common monomer. For the same purpose, the polymer having an inhibitor on its side chain may also form a polymer blend with another common polymer. The thickness of the polymerization-terminating layer is preferably 1 nm or more and 100 μm or less, more preferably 1 nm or more and 10 μm or less. Having the polymerization-terminating layer with thickness of 1 nm or more, the layer can be made without much difficulty. Having the polymerization-terminating layer with thickness of 100 μm or less, accurate information recording without deterioration in transparency is possible.

To improve the adhesiveness, the surface of the substrates is preferably treated with suitable process, before the polymer having an inhibitor on its side chain is applied thereon. Such process includes corona discharge treatment, plasma treatment, ozone treatment, alkali treatment, or the like.

When an inhibitor having a low-molecular weight is applied on to the substrate to form the polymerization-terminating layer, the surface of the substrate is preferably treated, for example, by corona discharge treatment, plasma treatment, ozone treatment, alkali treatment, or the like to improve the adhesiveness. It is possible to form the polymerization-terminating layer by coupling an inhibitor directly to the substrate. It is likely that such inhibitor has a halogen atom, where the inhibitor is coupled to the substrate, other than the radical trapping site.

[Structure of Holographic Recording Medium and Manufacturing Method Thereof]

The holographic recording medium according to the invention has a polymerization-terminating layer on at least one of the surface of the recording layer. The surface where the polymerization-terminating layer is formed could either be on the side of the optical incidence or on the opposite. One can also have the polymerization-terminating layer on both sides of the recording layer.

If the polymerization-terminating layer is formed on the side of the optical incidence of the recording layer, it is possible to avoid the dark reaction caused by exposure to natural light. Because natural light has lower light intensity compared to the recording beam, it does not reach deep inside the recording layer. Therefore the natural light can only reach to the photoinitiator which are dispersed close to the surface of the incidence on the recording layer. This would result in radicals to be generated only in the area close to the surface of the incidence. In order to trap such radicals, it is more effective to form a polymerization-terminating layer on the incidence surface of the recording layer rather than to disperse a polymerization inhibitor in the entire recording layer, as in conventional methods. Thus, presence of a polymerization-terminating layer on the surface of the incidence on the recording layer improves the shelf life of the holographic recording medium. It also eliminates the need for pre-exposure before recording because polymerization inhibitor is not dispersed in the recording layer.

In a holographic recording medium where the drives to record and reconstruct holograms focus the recording beam within the holographic recording media with an objective lens, it is particularly effective to form a polymerization-terminating layer on the opposite side of the incidence of the recording beam.

The holographic recording medium where the drives to record and reconstruct holograms focus the recording beam within the holographic recording media with an objective lens, has a transparent substrate, a recording layer, a gap layer, a reflective layer, and another substrate, as viewed from the recording beam-incident side. The reflective layer is not essential and may be eliminated if the information beam that has passed through the recording layer is read out to reconstruct the hologram.

The recording beam under such drives is irradiated to the holographic recording medium in such a way so that the beam is focused within the gap layer. An excessive amount of radicals are generated in the area of the recording layer close to the gap layer since the light intensity is very high. The radicals that has been excessively generated cause indiscriminate polymerization of monomers. This indiscriminate polymerization of monomers would result in polymeric aggregates in the recording layer close to the gap layer. The polymeric aggregates are not only irrelevant to the recording signals, but also the causes the light to scatter during data reconstruction and leads to deterioration in the signal-to-noise ratio of the reconstructed signals. Aggregation in the recording layer leads to undesirable consumption of initiator and monomer and results in decrease in the concentration of the initiator and monomer in the recording layer and in sensitivity during multiplex recording.

The presence of the polymerization-terminating layer on the recording layer on the opposite surface of the incidence, leads to effective trapping of the excessive radicals generated in the recording layer close to the gap layer. This would make it possible to control the polymerization reaction that is irrelevant to recording signals and also it would prevent excessive consumption of monomer. Because excessive consumption of monomers and initiators are prevented, deterioration of sensitivity during multiplex can be made small. Having radicals as the components of the polymerization termination layer, it is possible to recombine the radicals generated from the photoinitiator and the propagating radicals generated therefrom with the radicals in the polymerization-terminating layer. Polymerization terminates instantly as they recombine and the resultant polymer chains are chemically bonded to the polymerization termination layer. As a result, one can record the interference pattern accurately, and improve the archival life of the medium.

It is even more advantageous to have the polymerization-terminating layer on both surfaces of the recording layer because both of the effects stated above can be obtained.

FIG. 1 shows a cross-sectional view illustrating a holographic recording medium in an embodiment of the invention. The holographic recording medium 10 has a first transparent substrate 11, a polymerization-terminating layer 12, a recording layer 13, a polymerization-terminating layer 14, and a second transparent substrate 15, as viewed from the recording beam-incident side. The polymerization-terminating layer 12 on the first transparent substrate 11 may be eliminated if natural light that is irradiated has little effect on the recording layer.

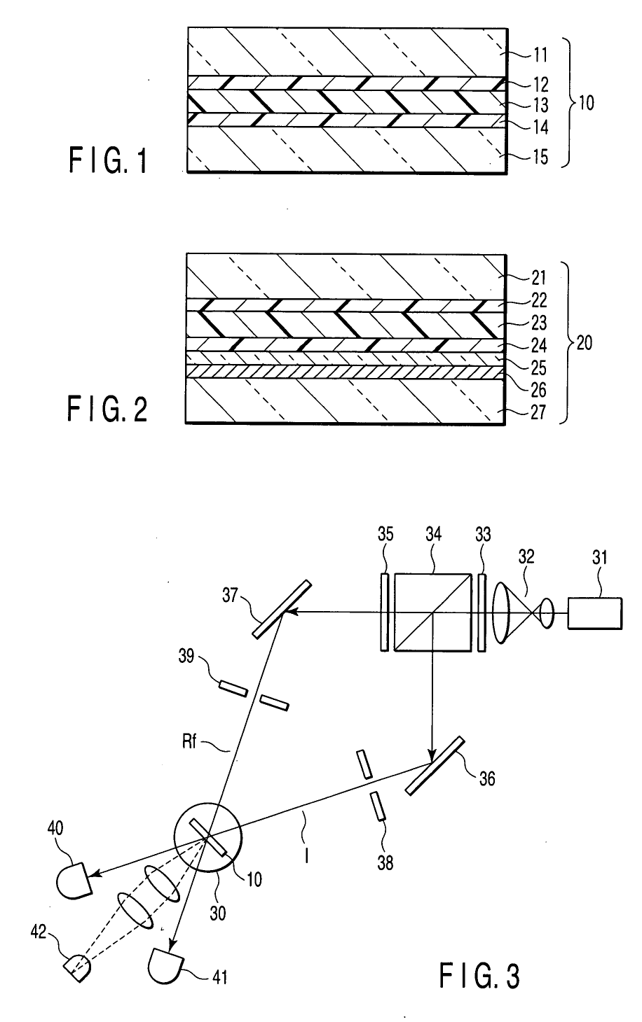

FIG. 2 is a cross-sectional view of a holographic recording medium in another embodiment of the invention. The holographic recording medium 20 has a first transparent substrate 21, a polymerization-terminating layer 22, a recording layer 23, a polymerization-terminating layer 24, a gap layer 25, a reflective layer 26, and a second transparent substrate 27, as viewed from the recording beam-incident side. The polymerization-terminating layer 22 on the first transparent substrate 21 may be eliminated if natural light that is irradiated has little effect on the recording layer. The second substrate is not necessarily transparent.

The holographic recording medium according to the embodiments can be fabricated, for example, by the following methods. The substrate can be of glass or plastic. In the fabrication of the holographic recording medium 10, the polymerization-terminating layer 12 is formed on the surface of the first transparent substrate 11; and the polymerization-terminating layer 14 is formed on the surface of the second transparent substrate 15. In the fabrication of the holographic recording medium 20, the polymerization-terminating layer 22 is formed on the surface of the first transparent substrate 21. The reflective layer 26, the gap layer 25 and the polymerization-terminating layer 24 are formed on the surface of the second transparent substrate 27. Before applying the polymerization-terminating layer, the surface to be coated may be treated to improve the adhesiveness by, for example, corona discharge treatment, plasma treatment, ozone treatment, alkali treatment, or the like.

The materials that comprise the recording-layer is prepared by mixing a matrix material, a photoactive monomer, and other components to form a solution of the recording-layer precursor.

The recording-layer precursor is applied on to the polymerization-terminating layer that is formed on the surface of one of the substrates. After applying the precursor solution, the other substrate is placed on top of the recording layer. The methods to apply the solution of the recording-layer precursor include casting and spin coating. Another way to apply the solution of the recording-layer precursor is as follows. Two substrates are placed to face each other and they are separated by a spacer to maintain a desired thickness of the recording layer. The orientation of the substrates is arranged in such a way so that polymerization-terminating layers, that are applied on to the surface of the substrates, face each other. The solution of the recording-layer precursor is injected into the gap.

The recording layer is formed by three-dimensional cross-linkage of the matrix material. When a primary aliphatic amine is used as a curing agent of epoxy, the three-dimensional cross-linkage of the matrix material proceeds even at room temperature. However, the matrix material may be heated to a temperature between 30 to 150° C. depending on the reactivity of the curing agent used.

The thickness of the recording layer is preferably 20 μm to 2 mm, more preferably 50 μm to 1 mm. Having the recording layer with thickness of 20 μm or more, sufficient memory capacity can be achieved allowing the differentiation from conventional optical recording media such as CD and DVD. Having the recording layer with thickness of 2 mm or less, deterioration in resolution can be prevented.

[Recording/Reconstructing Method]

According to an embodiment of the invention, holographic recording is carried out by allowing information beam and reference beam to interfere with each other within the recording layer of the holographic recording medium. Hologram that is to be recorded may either be a transmission hologram or a reflection hologram. The information beam and the reference beam can be interfered either by a two-axis geometry, where the two beams are incident on a holographic recording medium from angles different from each other, or by a collinear interference method where the two beams are incident on a holographic recording medium from the same angle.

FIG. 3 is a schematic diagram showing an example of a holographic recording/reconstructing apparatus according to an embodiment of the invention. The holographic recording/reconstructing apparatus is based on two-axis holography. The holographic recording medium 10 is mounted on a rotation stage 30. The light source device 31 may be of any light source that emits light capable to interfere in the recording layer 13 of the holographic recording medium 10. Linearly polarized laser beam is desirable, for coherent beam is essential. Examples of the lasers include a semiconductor laser, a He—Ne laser, an argon laser and a YAG laser. The light beam emitted from the light source device 31 is incident on a polarizing beam splitter 34 via a beam expander 32 and a polarizer 33. The beam expander 32 expands the light beam emitted from the light source device 31 to the diameter adapted for the holographic recording. The polarizer 33 rotates the plane of polarization of the light beam that has been expanded through the beam expander 32 so as to generate a light beam including an S-polarized beam and a P-polarized beam. For polarizer 33, a half-wave plate or a quarter-wave plate, for example, may be used.

Of the light beam that has passed through the wave plate 33, the S-polarized beam is reflected by the polarizing beam splitter 34 which is used as the information beam I, and the P-polarized beam is transmitted through the polarizing beam splitter 34 which is used as the reference beam Rf. It should be noted that the rotation direction of the plane of polarization of the light beam incident on the polarizing beam splitter 34 is controlled by the wave plate 33. By controlling the wave plate 33, the intensities of the information beam I and the reference beam Rf can be made equal at the position of the recording layer 13 of the holographic recording medium 10.

The information beam I that has been reflected by the polarizing beam splitter 34 is reflected by the mirror 36, which then passes through an electromagnetic shutter 38 to be exposed into the recording layer 13 of the holographic recording medium 10 mounted on the rotation stage 30.

On the other hand, the reference beam Rf which has transmitted through the polarizing beam splitter 34 is incident on a wave plate 35 where the polarization direction thereof is rotated 90° to form an S-polarized light beam. The reference beam Rf is reflected by a mirror 37, which then passes through an electromagnetic shutter 39 to be exposed into the recording layer 13 of the holographic recording medium 10, mounted on the rotation stage 30, in such a way so that the reference beam intersects with the information beam I therein. As a result, a transmission hologram is formed in the recording layer 13.

In order to reconstruct the recorded data, the electromagnetic shutter 38 is closed to shut off the information beam I and allows only the reference beam Rf to be exposed to the transmission hologram which has been formed within the recording layer 13 of the holographic recording medium 10. When passing through the holographic recording medium 10, the reference beam Rf is partly diffracted by the transmission hologram. The diffracted light beam is detected by a photodetector 40. A photodetector 41, which is to monitor the light beam transmitting through the holographic recording medium 10, is also provided.

In order to polymerize the unreacted photoactive monomer after the holographic recording, an ultraviolet light source device 42 and an optical system for ultraviolet light exposure may be provided as shown in FIG. 3. The completion of the polymerization of the monomer stabilizes the recorded hologram. Any light source that emits light that is capable of polymerizing the unreacted photoactive monomer may be used as the ultraviolet light source device 42. Taking the efficiency to emitting ultraviolet light into account, it is preferable to use, for example, a xenon lamp, a mercury lamp, a high-pressure mercury lamp, a mercury xenon lamp, a gallium nitride-based light emitting diode, a gallium nitride-based semiconductor laser, an excimer laser, third harmonic generation (355 nm) of a Nd:YAG laser, and fourth harmonic generation (266 nm) of a Nd:YAG laser as the ultraviolet light source 42.

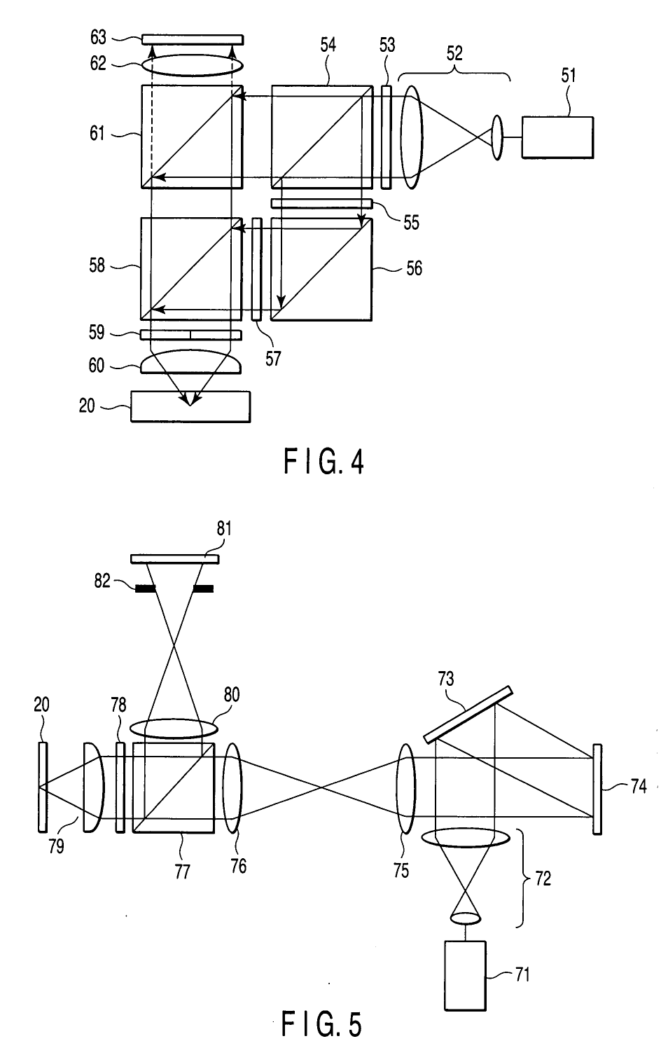

FIG. 4 is a schematic diagram showing an example of a reflection holographic recording/reconstructing apparatus according to an embodiment of the invention. Like the case of the holographic recording/reconstructing apparatus described above, it is preferable to use lasers that emit coherent and linearly polarized light beam for a light source device 51. Examples of the lasers include a semiconductor laser, a He—Ne laser, an argon laser and a YAG laser. The light beam emitted from the light source device 51 is expanded by a beam expander 52 and is incident on a wave plate 53 as a parallel beam. The wave plate 53 rotates the plane of polarization of the light beam or converts the light beam into a circular polarized light beam or an elliptical polarized light beam. The wave plate 53 generates a light beam including the P-polarized component and the S-polarized component. For the wave plate 53, a half-wave plate or a quarter-wave plate, for example, may be used.

Of the light beam that has transmitted through the wave plate 53, the S-polarized beam is reflected by the polarizing beam splitter 54 and is incident on a transmission spatial light modulator 55. This S-polarized beam later will be incident on the holographic recording medium 20 as the information beam I.

Of the light beam that has transmitted through the wave plate 53, the P-polarized beam passes through the polarizing beam splitter 54 which is to be used as the reference beam Rf as described below.

The transmission spatial light modulator 55 comprises a large number of pixels that are arrayed in a matrix like a transmission liquid crystal display, and the light emitted from each pixel can be switched to the P-polarized beam or to the S-polarized beam. In this manner, the transmission spatial light modulator 55 emits the information beam in which two-dimensional distribution of the plane of polarization is imparted corresponding to the data to be recorded.

The information beam that has passed through the transmission spatial light modulator 55 is incident on a polarizing beam splitter 56. The polarizing beam splitter 56 only reflects the S-polarized beam in the information beam and transmits the P-polarized beam. The S-polarized beam reflected by the polarizing beam splitter 56 passes through an electromagnetic shutter 57 in the form of the information beam having a two-dimensional distribution of intensity imparted thereto. The information beam is then incident on a polarizing beam splitter 58. The information beam is reflected by the polarizing beam splitter 58 which is then incident on a split wave plate 59.

The so-called split wave plate 59 has different optical characteristics on its right-half and on its left-half as shown in FIG. 4. The plane of polarization of the beam which is incident on the right-half of the split wave plate 59, is rotated by +45°. On the other hand, the plane of polarization beam that is incident on the left-half of the split wave plate 59 is rotated by −45°. For the polarized beam, where plane of rotation is rotated +45° to the S-polarized beam (or the polarized beam whose plane of rotation is rotated −45° to the P-polarized beam), we refer to A-polarized beam hereinafter. Likewise, for the polarized beam where the plane of rotation is rotated −45° to the S-polarized beam (or the polarized beam whose plane of rotation is rotated +45° to the P-polarized beam), we refer to B-polarized beam hereinafter. A half-wave plate, for example, is used for each half of the split wave plate 59.

The A-polarized beam and the B-polarized beam which have transmitted through the split wave plate 59 are incident on the holographic recording medium 20 through an objective lens 60. The two beams pass through the first transparent substrate 21, the polymerization-terminating layer 22, the recording layer 23, the polymerization-terminating layer 24, and the gap layer 25, and are focused on the reflective layer 26.

On the other hand, the P-polarized beam (the reference beam) that has transmitted through the polarizing beam splitter 54 is partly reflected by the beam splitter 61 to pass through the polarizing beam splitter 58. The reference beam that has transmitted through the polarizing beam splitter 58 is incident on the split wave plate 59. The plane of polarization of the light beam, which is incident on the right-half of the split wave plate 59, is rotated by +45° and is converted to B-polarized beam as it passes through the split wave plate 59. On the contrary, the beam component which is incident on the left-half of the split wave plate 59 is rotated by −45° and is converted to A-polarized beam as it passes through the split wave plate 59. The A-polarized beam and the B-polarized beam are incident on the holographic recording medium 20 through the objective lens 60 which then pass through the first transparent substrate 21, the polymerization-terminating layer 22, the recording layer 23, the polymerization-terminating layer 24, and the gap layer 25, and are focused on the reflective layer 26.

As described above, at the right-half of the split wave plate, the information beam is converted to A-polarized beam, whereas the reference beam is converted to B-polarized beam. On the contrary, at the left-half of the split wave plate, the information beam is converted to B-polarized beam, whereas the reference beam is converted to A-polarized beam. The information beam and the reference beam are focused on the reflective layer 26 of the holographic recording medium 20. Thus, interference occurs between the information beam incident on the recording layer 23, deriving directly through several optical instruments from the light source 51 as stated above, and the reference beam that has been reflected back by the reflective layer 26. The same is true for the interference between the reference beam deriving directly from the light source 51 and the information beam that has been reflected back by the reflective layer 26. By this way, distribution of optical properties that characterizes the information beam is represented in the recording layer 23. On the other hand, interference does not occur between the information beam deriving directly from the light source 51 and the information beam that has been reflected back by the reflective layer 26. The same is also true for the reference beam deriving directly from the light source 51 and the reference beam that has been reflected back by the reflective layer 26.

The read-out of the recorded data in the holographic recording medium 20 is as follows.

When the electromagnetic shutter 57 is shut, the reference beam which is P-polarized is solely incident on the split wave plate 59. The plane of polarization of the reference beam that has been incident on the right half of the split wave plate 59 is rotated +45° as it passes through to form the B-polarized beam. On the other hand, the plane of polarization of the reference beam that has been incident on the left half of the split wave plate 59 is rotated −45° as it passes through to form the A-polarized beam. The A-polarized beam and the B-polarized beam are incident on the holographic recording medium 20 through the objective lens 60. The objective lens 60 is located in such a way that the two beams are both focused on the reflective layer 26 which is located underneath the first transparent substrate 21, the polymerization-terminating layer 22, the recording layer 23, the polymerization-terminating layer 24, and the gap layer 25.

Distribution of optical characteristics corresponding to the data which has been recorded is formed in the recording layer 23 of the holographic recording medium 20. It follows that the A-polarized beam and the B-polarized beam incident on the holographic recording medium 20 are partly diffracted by the refractive index-modulated region formed in the recording layer 23. The diffracted light passes through the transparent substrate as the reconstructed light. This refers to the reconstruction of the information beam.

The reconstructed beam from the holographic recording medium 20 is collimated by the objective lens 60, which is then incident on the split wave plate 59. The B-polarized beam incident on the right half of the split wave plate 59 is converted to a P-polarized beam, and the A-polarized beam incident on the left half of the split wave plate 59 is converted to a P-polarized light. In this way, reconstructed beam is obtained as the P-polarized beam.

The reconstructed beam passes through the polarizing beam splitter 58. The reconstructed beam which has transmitted through the polarizing beam splitter 58 partly transmits through the beam splitter 61 and the imaging lens 62, to form an image on a two-dimensional photodetector 63. The image that is detected on the photodetector 63 is the reconstruction of the image which had been displayed on the transmission spatial light modulator 55 when data have been recorded. In this manner, the data which have been recorded in the holographic recording medium 20 can be read out.

On the other hand, the remaining portion of the A-polarized beam and the B-polarized beam incident on the holographic recording medium 20 through the split wave plate 59 are reflected back by the reflective layer 26. The reflected A-polarized beam and the B-polarized beam are collimated by the objective lens 60. When A-polarized beam passes through the right half of the split wave plate 59, it is converted to an S-polarized beam. When the B-polarized beam passes through the left half of the split wave plate 59, it is converted to an S-polarized beam. The S-polarized beams that have passed through the split wave plate 59 are reflected by the polarizing beam splitter 61, and would not reach the two-dimensional photodetector 63. Therefore, the recording-reconstructing apparatus, shown in FIG. 4, makes it possible to reconstruct the information with excellent signal-to-noise ratio.

The holographic recording medium according to the invention can suitably be multiplexed. The geometry of the holography that is suitable for multiplexing, can either be transmission or reflection.

It is possible, if necessary, to illuminate the recording layer with a uniform light after recording to polymerize the remaining monomers. It is also possible to diffuse oxygen into the recording layer of the holographic recording medium under an oxygen-rich atmosphere after recording to quench the radical species within the holographic recording medium.

FIG. 5 schematically shows a holographic recording/reconstructing apparatus using the collinear interference geometry according to an embodiment of the invention. The construction of the apparatus will be described below in detail. The apparatus provides geometry of so-called collinear interference in which the information beam and the reference beam are modulated with a single spatial light modulator. Like the cases of the holographic recording/reconstructing apparatuses described above, it is preferable to use lasers that emit coherent and linearly polarized light beam for the light source 71. Examples of lasers include a semiconductor laser, a He—Ne laser, an argon laser and a YAG laser. The light source device 71 is also capable of controlling the wavelength of the light beam emitted therefrom. A beam expander 72 expands and collimates the light beam emitted from the light source device 71. The collimated light beam is reflected by a mirror 73 to the reflection spatial light modulator 74. The reflection type spatial light modulator 74 comprises a large number of pixels that are arrayed in a two-dimensional lattice. Each pixel on the reflection spatial light modulator 74 can independently change the direction or the polarization rotation of the reflected light. This enables to display information beam and reference beam simultaneously, where both beams are spatially modulated in a form of a two-dimensional pattern. The reflection spatial light modulators include, for example, a digital mirror device, a reflection liquid crystal device, or a reflection modulating device that operates under a magneto-optical effect. FIG. 5 shows the case where a digital mirror device is used as the reflection spatial modulator. The recording light reflected by the reflection spatial modulator 74 is incident on a polarizing beam splitter 77, after passing through imaging lenses 75 and 76. The direction of the polarization is adjusted in advance when beam is emitted from the light source device 71, in such a way so that the recording light beam could transmit through the polarizing beam splitter 77. The recording light beam that has transmitted through the polarizing beam splitter 77 passes through a wave plate 78 and is incident on the holographic recording medium 20 after passing through an objective lens 79. The recording light is focused on the surface of the reflective layer 26 of the holographic recording medium 20. The wave plate 78 could be, for example, a half-wave plate or a quarter-wave plate.

The reconstruction of the information beam is retrieved by the following procedures. When the reference beam which has been spatially modulated by the reflection spatial modulator 74 passes through the holographic recording medium 20, the spatially modulated reference beam is partly diffracted by the refractive index modulated region to form a reconstructed information beam. The reconstructed light beam is reflected by the reflective layer 26 which then passes through the objective lens 79 and the wave plate 78. When passing through the wave plate 78, the plane of polarization of the reconstructed light beam is rotated so that the direction of the polarization is different from the original reference beam. The reconstructed and rotated information beam is reflected by the polarizing beam splitter 77. It should be noted that the rotation angle of the reconstructed information light beam at the wave plate 78 is preferably controlled in such a way so that the reconstructed light beam is reflected the most at the polarizing beam splitter 77. The reconstructed light beam reflected by the polarizing beam splitter 77 is detected by a two-dimensional photodetector 81 as the reconstructed image of the information light beam. It should be noted that an iris diaphragm 82 is arranged in front of the photodetector 81 in order to improve the signal-to-noise ratio of the reconstructed information light beam.

### EXAMPLES

The present invention will be described in details with reference to Examples of the invention.

### Example 1

First, 2.16 g of 1,6-hexanediol diglycidyl ether (denacol Ex-212, Nagase Chemtex) as an epoxy compound, 4.80 g of dodecenyl succinic anhydride as a curing agent, and 0.39 g of 2,4,6-tribromophenyl acrylate as a photoactive monomer were mixed and dissolved to prepare a uniform solution. Then, 0.033 g of Irgacure® 784 (Ciba Specialty Chemicals) as a photoinitiator and 50 μL of 2,4,6-tris(dimethylaminomethyl)phenol (DMP-30, Polysciences) were added to the solution before it was defoamed to provide a precursor solution for the recording layer (referred to as the precursor 1 for the recording layer hereinafter).

As a polymer having radical sites, poly(4-methacryloyl-2,2,6,6-tetramethylpiperidine-1-oxyl) was prepared according to the method by Okawara et al. (Journal of Polymer Science: Polymer Chemistry Edition, Vol. 10, 3295, 1972). Then, 100 mg of poly(4-methacryloyl-2,2,6,6-tetramethylpiperidine-1-oxyl) was dissolved in 100 ml of tetrahydrofuran under nitrogen atmosphere to prepare a solution of polymerization-terminating layer material (referred to as the precursor 1 for the polymerization-terminating layer hereinafter). The precursor 1 for the polymerization terminating layer was applied to two glass substrates by spin coating, respectively, and dried sufficiently to form polymerization-terminating layers thereon.

The precursor 1 for the recording layer was injected into the gap between two glass substrates each having the polymerization-terminating layer arranged with a spacer of a polytetrafluoroethylene (PTFE) sheet interposed therebetween. The resultant structure was heated to 60° C. in an oven for 45 hours, thereby providing a sample of a holographic recording medium having a recording layer of 200 μm in thickness.

A hologram was recorded on the prepared holographic recording medium provided with the polymerization-terminating layer by two-axis interference method, and the diffraction efficiency was determined. Separately, the sample was left to stand under irradiation of light for 1 hour and the diffraction efficiency was determined once again to evaluate the storage stability.

The holographic recording efficiency is evaluated by M/# (M number) indicating the recording dynamic range, which is defined by the following Formula expressed as a function of ηᵢ. ηᵢ is the diffraction efficiency of the i-th hologram, when n pages of holograms are recorded and reconstructed repeatedly by angle multiplexing recording, in the same region of the recording layer of holographic recording medium until photoactive monomers and initiators are used up and recording is no longer possible.

$$M / \# = {\sum }_{i = 1}^{n} {η}_{i}$$

### Comparative Example 1

A medium containing an inhibitor dispersed in the recording medium was prepared. 0.017 g of 4-hydroxy-2,2,6,6-tetramethylpiperidine-1-oxyl (Tokyo Kasei Kogyo) as an inhibitor was dissolved in 10 g of Denacol Ex-212. One gram of the solution was mixed with 99 g of Denacol 212. One gram of the mixture was mixed with 1.16 g of Denacol Ex-212, 4.80 g of dodecenylsuccinic anhydride, 0.39 g of 2,4,6-tribromophenyl acrylate as a photoactive monomer, 0.033 g of Irgacure 784 as a photoinitiator and 50 μl of DMP-30, which was stirred and defoamed to give a precursor for the recording layer of Comparative Example (referred to as the precursor 1′ for the recording layer hereinafter).

The precursor 1′ for the recording layer was injected into the gap between two glass substrates arranged with a spacer of a polytetrafluoroethylene (PTFE) sheet interposed therebetween. The resultant structure was heated to 60° C. in an oven for 45 hours, thereby providing a sample of a holographic recording medium having a recording layer of 200 μm in thickness.

A hologram was recorded on the prepared holographic recording medium having no polymerization-terminating layer by two-axis interference method without pre-exposure, and the diffraction efficiency was determined. Separately, the sample was left to stand under irradiation of light for 1 hour and the diffraction efficiency was determined once again to evaluate the storage stability.

### Example 2

The precursor 1 for the polymerization-terminating layer was applied on the gap layer of a glass substrate having a reflective layer by spin coating and dried to form a polymerization-terminating layer.

The precursor 1 for the recording layer described in Example 1 was injected into the gap between the glass substrate having the polymerization-terminating layer formed and a transparent glass substrate, the polymerization-terminating layer being arranged toward the recording layer, with a spacer of a polytetrafluoroethylene (PTFE) sheet interposed therebetween. The resultant structure was heated to 60° C. in an oven for 45 hours, thereby providing a sample of a holographic recording medium having a recording layer of 200 μm in thickness.

The recording medium was evaluated by the collinear interference method as follows: A recording beam was modulated spatially, by coding digital data into a two-dimensional image and displaying the obtained image in a spatial light modulator having 400×400 pixels. The image was recorded on the recording medium by the collinear interference method using the modulated beam. A reference beam (reference beam pattern) was applied to the recording medium one hour after recording, to give a reconstructed image. The reconstructed image was read out by a photodetector in the 256-grade gray scale, and the signal-to-noise ratio (SNR) on the recording medium was determined.

The SNR is calculated according to the following Formula. In the formula, μₒₙ represents the average brightness of the pixels in the recorded bright area, while μ_{off} represents the average brightness of the pixels in the dark area; and σₒₙ and σ_{off} represent the dispersion of the pixels in the bright and dark areas, respectively.

$$SNR = \frac{{μ}_{on} - {μ}_{off}}{\sqrt{{σ}_{on}^{2} + {σ}_{off}^{2}}}$$

### Comparative Example 2

The precursor 1′ for the recording layer described in Comparative Example 1 was injected into the gap between a glass substrate having a reflective layer and a transparent glass substrate. A spacer of a polytetrafluoroethylene (PTFE) sheet was interposed therebetween. The resultant structure was heated to 60° C. in an oven for 45 hours, thereby providing a sample of a holographic recording medium having a recording layer of 200 μm in thickness.

Page data was recorded on the recording medium by collinear interference method, and the signal-to-noise ratio (SNR) was determined one hour after recording.

### Example 3

Poly(2-hydroxy-4-vinylbenzaldehyde-N-isopropylnitrone) was prepared according to the method by Heinenberg et al. (M. Heinenberg, B. Menges, S. Mittler, and H. Ritter, “Polymeric Nitrons. 2. Synthesis, Irradiation and Waveguide Mode Spectroscopy of Polymeric Nitrons Derived from Polymeric Benzaldehydes and N-Isopropylhydroxylamine”, Macromolecules 35, 3448, (2002)). One hundred mg of the poly(2-hydroxy′-4-vinylbenzaldehyde-N-isopropyl nitrone) obtained was dissolved in 100 ml of tetrahydrofuran, to give a precursor 2 for the polymerization-terminating layer. The precursor 2 for the polymerization-terminating layer was applied to two glass substrates by spin coating. Then, a sample of a holographic recording medium was prepared as in Example 1, which was then evaluated in a similar manner as in Example 1.

### Example 4

The precursor 1 for the polymerization-terminating layer described in Example 1 was applied to a glass substrate by spin coating and dried sufficiently to form a polymerization-terminating layer. The precursor 1 for the recording layer was injected into the gap between a glass substrate having a polymerization-terminating layer and a glass substrate having no polymerization-terminating layer. A spacer of a polytetrafluoroethylene (PTFE) sheet was interposed therebetween. The polymerization-terminating layer was applied on the inner surface so that it comes in contact with the recording layer. The transparent substrate, the polymerization-terminating layer, the recording layer, the gap layer, and the other substrate were stacked in this order, as viewed from the recording beam incidence. The resultant structure was heated to 60° C. in an oven for 45 hours, thereby providing a sample of a holographic recording medium having a recording layer of 200 μm in thickness.

A hologram was recorded on the holographic recording medium by two-axis interference method, and the diffraction efficiency was determined. Separately, the sample was left to stand under irradiation of light for 1 hour and the diffraction efficiency was determined once again to evaluate the storage stability.

### Example 5

4-methacryloyl-1-hydroxy-2,2,6,6-tetramethylpiperidine hydrochloride was prepared according to the method by T. Kurosaki, O. Takahashi and M. Okawara, “Polymers Having Stable Radicals. II. Synthesis of Nitroxyl Polymers from 4-Methacryloyl Derivatives of 1-Hydroxy-2,2,6,6-tetramethylpiperidine”, Journal of Polymer Science: Polymer Chemistry Edition, 12, 1407, (1974). The hydrochloride was dissolved in 12.5 g of methanol to which 130 μl of glycidyl methacrylate and 0.164 g of 2,2′-azobis(isobutylonitrile) were added, followed by copolymerization at 60° C. The resultant polymer was then dissolved in 100 ml of pyridine, to which 20 g of triethylamine was added, and the mixture was stirred for 24 hours under supply of oxygen. The 4-methacryloyl-1-hydroxy-2,2,6,6-tetramethylpiperidine hydrochloride was oxidized into a nitroxide under a basic environment and in the presence of oxygen. After the reaction, the product was dried under reduced pressure. One hundred mg of the dry polymer was dissolved in 100 ml of tetrahydrofuran to give a solution of polymerization-terminating layer precursor (referred to as the precursor 3 for the polymerization-terminating layer hereinafter). One ml of 0.02M diethylenetriamine solution in tetrahydrofuran was added to the precursor 3 for the polymerization-terminating layer, and the mixture was applied to two glass substrates by spin coating, respectively, and dried sufficiently and then heated at 60° C. The polymerization-terminating layer was cross-linked by the oxirane ring in the glycidyl methacrylate unit and diethylenetriamine by heating.

The precursor 1 for the recording layer was injected into the gap between two glass substrates having the polymerization-terminating layer. A spacer of a polytetrafluoroethylene (PTFE) sheet was interposed therebetween. The resultant structure was heated to 60° C. in an oven for 45 hours, thereby providing a sample of a holographic recording medium having a recording layer of 200 μm in thickness.

A hologram was recorded on the holographic recording medium by two-axis interference method, and the diffraction efficiency was determined. Separately, the sample was left to stand under irradiation of light for 1 hour and the diffraction efficiency was determined once again to evaluate the storage stability.

Results of diffraction efficiency, M/#, and M/# after storage for one hour under light, for Comparative Example 1 and Examples 1, 3, 4, and 5 are summarized in Table 1. The holographic recording media of Examples 1, 3, 4, and 5 showed superiority in diffraction efficiency, M/#, and M/# after storage for one hour under light compared to those of Comparative Example 1.

In addition, the SNR of the medium of Comparative Example 2 was 1.1, while the SNR of that of Example 2 was 2.3. This shows that the medium of Example 2 was better in the SNR compared to the medium of Comparative Example 2.

TABLE 1

| | Diffraction | | M/# after |
|---|---|---|---|
| | efficiency | | storage for 1 H |
| | (%) | M/# | in darkness |
| Comparative | 24 | 2.3 | 1.5 |
| Example 1 | | | |
| Example 1 | 73 | 7.1 | 5.9 |
| Example 3 | 53 | 4.9 | 4.0 |
| Example 4 | 69 | 7.3 | 5.2 |
| Example 5 | 79 | 7.5 | 4.8 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A holographic recording medium, comprising:
a recording layer containing a matrix material, a photoactive monomer having at least one ethylenic unsaturated bond and a photoinitiator both dispersed in the matrix material; and
a polymerization-terminating layer formed on at least one surface of the recording layer.

2. The medium according to claim 1, wherein the polymerization-terminating layer is formed on a recording beam incidence surface of the recording layer.

3. The medium according to claim 1, wherein the polymerization-terminating layer is formed on the opposite surface of a recording beam incidence surface of the recording layer.

4. The medium according to claim 1, wherein the polymerization-terminating layers are formed on both surfaces of the recording layer.

5. The medium according to claim 1, wherein the polymerization-terminating layer comprises an inhibitor.

6. The medium according to claim 1, wherein the matrix material is a cross-linked polymer matrix formed of a cured resin of an epoxy compound and a curing agent.

7. The medium according to claim 1, wherein the monomer is contained in the recording layer in a range of 1 to 50 wt %.

8. The medium according to claim 1, wherein the photoinitiator is contained in the recording layer in a range of 0.1 to 20 wt %.

9. A holographic recording medium, comprising:
a first transparent substrate;
a polymerization-terminating layer;
a recording layer containing a matrix material, a photoactive monomer having an ethylenic unsaturated bond, and a photoinitiator both dispersed in the matrix material; and
a second transparent substrate.

10. The medium according to claim 9, further comprising a polymerization-terminating layer between the recording layer and the second transparent substrate.

11. The medium according to claim 9, wherein the polymerization-terminating layer comprises an inhibitor.

12. The medium according to claim 9, wherein the matrix material is a cross-linked polymer matrix formed of a cured resin of an epoxy compound and a curing agent.

13. The medium according to claim 9, wherein the monomer is contained in the recording layer in a range of 1 to 50 wt %.

14. The medium according to claim 9, wherein the photoinitiator is contained in the recording layer in a range of 0.1 to 20 wt %.

15. A holographic recording medium comprising:
a transparent substrate;
a recording layer containing a matrix material, a photoactive monomer having an ethylenic unsaturated bond, and a photoinitiator both dispersed in the matrix material;
a polymerization-terminating layer;
a gap layer;
a reflective layer; and
another substrate.

16. The medium according to claim 15, further comprising a polymerization-terminating layer between the transparent substrate and the recording layer.

17. The medium according to claim 15, wherein the polymerization-terminating layer comprises an inhibitor

18. The medium according to claim 15, wherein the matrix material is a cross-linked polymer matrix formed of a cured resin of an epoxy compound and a curing agent.

19. The medium according to claim 15, wherein the monomer is contained in the recording layer in a range of 1 to 50 wt %.

20. The medium according to claim 15, wherein the photoinitiator is contained in the recording layer in a range of 0.1 to 20 wt %.
